(19) United States
(12) Patent Application Publication
(10) Pub. No.: US 2014/0049353 A1
(43) Pub. Date: Feb. 20, 2014

(54) INDUCTOR AND METHOD OF MANUFACTURING INDUCTOR

(71) Applicant: SAMSUNG ELECTROMECHANICS CO., LTD., Suwon-si (KR)

(72) Inventors: Chan YOON, Gyeonggi-do (KR); Sung Kwon WI, Suwon-si (KR); Young Ghyu AHN, Suwon-si (KR); Young Seuck YOO, Suwon-si (KR)

(73) Assignee: SAMSUNG ELECTRO-MECHANICS CO., LTD., Suwon-si (KR)

(21) Appl. No.: 13/968,815

(22) Filed: Aug. 16, 2013

(30) Foreign Application Priority Data
Aug. 17, 2012 (KR) 10-2012-0090088

(51) Int. Cl. H01F 27/28; H01F 41/02

(52) U.S. Cl. CPC H01F 27/28; H01F 41/02
USPC 336/227; 29/604

(57) ABSTRACT

The present invention relates to an inductor and a method of manufacturing an inductor and provides an inductor which can minimize the area required for mounting, reduce parasitic capacitance generated between a circuit pattern of a substrate and a coil pattern of the inductor, and be efficiently manufactured by providing both of a first external electrode portion and a second external electrode portion on one of six surfaces of the inductor while including a coil pattern portion; an insulating portion; the first external electrode portion; and the second external electrode portion.

### CROSS-REFERENCE TO RELATED APPLICATIONS

Claim and incorporate by reference domestic priority application and foreign priority application as follows:

### “CROSS REFERENCE TO RELATED APPLICATION

This application claims the benefit under 35 U.S.C. Section 119 of Korean Patent Application Serial No. 10-2012-0090088, entitled filed Aug. 17, 2012, which is hereby incorporated by reference in its entirety into this application.”

### BACKGROUND OF THE INVENTION

1. Field of the Invention

The present invention relates to an inductor and a method of manufacturing an inductor.

2. Description of the Related Art

As disclosed in Patent Document 1 etc., a conventional typical inductor has a rectangular parallelepiped shape and a structure in which external electrodes are formed on one surface and the other surface opposite to the one surface.

FIG. 1 is a view schematically showing the state in which the conventional typical inductor is combined with a substrate.

Referring to FIG. 1, in order to mount the inductor on a surface of the substrate, external electrodes 14b and 14a of the inductor are in contact with conductive patterns 21 and 22 formed on one surface of the substrate, respectively, and solder pastes 15 and 16 are provided to firmly adhere and fix the external electrodes 14b and 14a to the conductive patterns 21 and 22.

At this time, as shown, since the solder pastes 15 and 16 are applied on side surfaces of the external electrodes 14b and 14a of the inductor, there was a limit in reducing the area required for mounting one inductor on the substrate.

Further, there are continuous efforts to form a circuit pattern provided on the substrate finely for miniaturization and slimming of various electronic devices. Accordingly, there is a rising need to form the circuit pattern in a region between the inductor and the substrate.

Furthermore, a multilayer circuit board has been widely used to meet miniaturization and integration. In case of the multilayer circuit board, a conductor pattern is also formed inside a substrate to perform a function of transmitting signals.

However, as shown in FIG. 1, when mounting the conventional inductor, in which a coil 11 is wound on a surface parallel to the substrate, on the substrate, a significant amount of parasitic capacitance is generated between a conductor pattern 30 formed on the surface of the substrate or an inner conductor pattern 40 of the multilayer circuit board and the coil 11 inside the inductor mounted on the substrate to cause various performance degradations.

Further, since the conventional typical inductor disclosed in Patent Document 1 etc. requires a separate dipping process etc. to form the external electrode in the inductor having a coil portion inside, there was a limit in improving manufacturing efficiency.

### RELATED ART DOCUMENT

### Patent Document

Patent Document 1: Korean Patent Laid-open Publication No. 2010-0129580

### SUMMARY OF THE INVENTION

The present invention has been invented in order to overcome the above-described problems and it is, therefore, an object of the present invention to provide an inductor capable of minimizing the area required for mounting, reducing parasitic capacitance generated between a circuit pattern of a substrate and a coil pattern of the inductor, and being efficiently manufactured.

Further, it is another object of the present invention to provide an inductor capable of improving inductance and Q characteristics by preventing interference with a magnetic flux generated according to a current flow in a coil pattern portion.

Further, it is another object of the present invention to provide a method of manufacturing an inductor that can minimize the area required for mounting, reduce parasitic capacitance generated between a circuit pattern of a substrate and a coil pattern of the inductor, and improve manufacturing efficiency.

Further, it is another object of the present invention to provide a method of manufacturing an inductor that can improve inductance and Q characteristics by preventing interference with a magnetic flux generated according to a current flow in a coil pattern portion.

In accordance with one aspect of the present invention to achieve the object, there is provided an inductor having a hexahedral shape, including: a coil pattern portion formed by winding a conductive wire made of a conductive material on at least one plane at least more than one turn; an insulating portion having the coil pattern portion inside; a first external electrode portion having at least one surface exposed to an outer surface of the insulating portion and electrically connected to one end of the coil pattern portion; and a second external electrode portion having at least one surface exposed to the outer surface of the insulating portion and electrically connected to the other end of the coil pattern portion, wherein both of the first external electrode portion and the second external electrode portion are provided on one of six surfaces of the inductor.

At this time, the surface of the first external electrode portion and the second external electrode portion, which is vertical to the surface on which the coil pattern portion is wound, may have a larger area than the other surfaces.

Further, the first external electrode portion and the second external electrode portion may be provided only in a region outside the region on which the coil pattern portion is projected in the direction vertical to the surface on which the coil pattern portion is wound.

Further, one of the surfaces of the first external electrode portion and the second external electrode portion, which are parallel to the surface on which the coil pattern portion is wound, may be parallel to a lower surface of the coil pattern portion, and the other of the surfaces of the first external electrode portion and the second external electrode portion, which are parallel to the surface on which the coil pattern portion is wound, may be formed in a position higher than an upper surface of the coil pattern portion.

In accordance with another aspect of the present invention to achieve the object, there is provided an inductor including: a base substrate, a first pattern layer, a second pattern layer, and a third pattern layer, wherein the first pattern layer includes a first coil pattern, a first external electrode first layer electrically connected to one end of the first coil pattern, a second external electrode first layer, and a first insulating layer while being provided on an upper surface of the base substrate, the second pattern layer includes a second coil pattern, a first external electrode second layer, a second external electrode second layer electrically connected to one end of the second coil pattern, and a second insulating layer while being provided on an upper surface of the first pattern layer, the third pattern layer includes a first external electrode third layer, a second external electrode third layer, and a resin portion while being provided on an upper surface of the second pattern layer, the other end of the first coil pattern and the other end of the second coil pattern are electrically connected through a via, an upper surface of the first external electrode first layer is in contact with a lower surface of the first external electrode second layer and an upper surface of the first external electrode second layer is in contact with a lower surface of the first external electrode third layer so that the first external electrode first layer, the first external electrode second layer, and the first external electrode third layer form a first external electrode portion, an upper surface of the second external electrode first layer is in contact with a lower surface of the second external electrode second layer and an upper surface of the second external electrode second layer is in contact with a lower surface of the second external electrode third layer so that the second external electrode first layer, the second external electrode second layer, and the second external electrode third layer form a second external electrode portion, all of the base substrate, the first pattern layer, the second pattern layer, and the third pattern layer have a hexahedral shape, and the first external electrode portion and the second external electrode portion are provided on the same plane.

In accordance with still another aspect of the present invention to achieve the object, there is provided an inductor including: a hexahedral base substrate; a first coil pattern provided by forming a pattern made of a conductive material on an upper surface of the base substrate in a coil shape; a first external electrode first layer formed of a conductive material on an upper surface of the base substrate and connected to one end of the first coil pattern; a second external electrode first layer formed of a conductive material on the upper surface of the base substrate and positioned on the same surface as the surface on which the first external electrode first layer is positioned among the four surfaces vertical to the upper surface of the base substrate; a first insulating layer for covering an exposed surface of the first coil pattern and the upper surface of the base substrate; a second coil pattern provided by forming a pattern made of a conductive material on an upper surface of the first insulating layer in a coil shape; a second external electrode second layer formed of a conductive material on an upper surface of the second external electrode first layer and connected to one end of the second coil pattern; a first external electrode second layer formed of a conductive material on an upper surface of the first external electrode first layer; a second insulating layer for covering an exposed surface of the second coil pattern and the upper surface of the first insulating layer; a first external electrode third layer formed of a conductive material on an upper surface of the first external electrode second layer; a second external electrode third layer formed of a conductive material on an upper surface of the second external electrode second layer; and a resin portion for covering an upper surface of the second insulating layer.

At this time, a first external electrode portion consisting of the first external electrode first layer, the first external electrode second layer, and the first external electrode third layer and a second external electrode portion consisting of the second external electrode first layer, the second external electrode second layer, and the second external electrode third layer may be provided only in a region outside the region on which the first coil pattern and the second coil pattern are projected in the direction vertical to the upper surface of the base substrate.

In accordance with still another aspect of the present invention to achieve the object, there is provided a method of manufacturing an inductor, including the steps of: (A) forming a first coil pattern, a second external electrode first layer, and a first external electrode first layer electrically connected to one end of the first coil pattern on a surface of a base substrate; (B) forming a first insulating layer for covering the first coil pattern, the first external electrode first layer, an exposed surface of the second external electrode first layer, and an upper surface of the base substrate; (C) removing the first insulating layer on a portion of the first coil pattern, an upper surface of the first external electrode first layer, and an upper surface of the second external electrode first layer; (D) forming a second coil pattern having one end electrically connected to the portion of the first coil pattern, a first external electrode second layer in contact with the upper surface of the first external electrode first layer, and a second external electrode second layer electrically connected to the other end of the second coil pattern and in contact with the upper surface of the second external electrode first layer on an upper surface of the first insulating layer; (E) forming a second insulating layer for covering the second coil pattern, the first external electrode second layer, an exposed surface of the second external electrode second layer, and the upper surface of the first insulating layer; (F) removing the second insulating layer on an upper surface of the first external electrode second layer and an upper surface of the second external electrode second layer; and (G) forming a first external electrode third layer having a lower surface in contact with the upper surface of the first external electrode second layer, a second external electrode third layer having a lower surface in contact with the upper surface of the second external electrode second layer, and a resin portion provided on an upper surface of the second insulating layer.

Here, the steps (A), (D), and (G) may include the steps of: forming a seed layer; forming a photoresist pattern on an upper surface of the seed layer; forming a plating portion by performing plating using the seed layer and the photoresist pattern; and removing the photoresist pattern and the seed layer in the remaining region of the seed layer in which the plating portion is not formed.

Further, the first insulating layer and the second insulating layer may be made of a photosensitive insulating material, the step (B) may be performed by developing after exposing a portion of the first insulating layer, and the step (F) may be performed by developing after exposing a portion of the second insulating layer.

Further, a first external electrode portion consisting of the first external electrode first layer, the first external electrode second layer, and the first external electrode third layer and a second external electrode portion consisting of the second external electrode first layer, the second external electrode second layer, and the second external electrode third layer may be provided only in a region outside the region on which the first coil pattern and the second coil pattern are projected in the direction vertical to the upper surface of the base substrate.

Further, the method of manufacturing an inductor may further include, after the step (G), the step of plating nickel or tin on at least one of exposed surfaces of the first external electrode portion and the second external electrode portion.

In accordance with still another aspect of the present invention to achieve the object, there is provided a method of manufacturing a hexahedral inductor, which forms a coil pattern portion formed by winding a conductive wire made of a conductive material on at least one plane at least more than one turn, a first external electrode portion electrically connected to one end of the coil pattern portion, and a second external electrode portion electrically connected to the other end of the coil pattern portion on one surface of a base substrate, wherein the coil pattern portion, the first external electrode portion, and the second external electrode portion are formed by a photoresist method, and the first external electrode portion and the second external electrode portion are formed only in a region outside the region on which the coil pattern portion is projected in the direction vertical to the surface on which the coil pattern portion is wound.

At this time, one of surfaces of the first external electrode portion and the second external electrode portion, which are parallel to the surface on which the coil pattern portion is wound, may be parallel to a lower surface of the coil pattern portion, and the other of the surfaces of the first external electrode portion and the second external electrode portion, which are parallel to the surface on which the coil pattern portion is wound may be formed in a position higher than an upper surface of the coil pattern portion.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a view schematically showing the state in which a conventional typical inductor is combined with a substrate;

FIG. 2a is a view schematically showing an inductor in accordance with an embodiment of the present invention;

FIG. 2b is a view schematically showing a main part of the inductor in accordance with an embodiment of the present invention;

FIG. 3 is a combined perspective view schematically showing the inductor in accordance with an embodiment of the present invention;

FIG. 4a is a plan view of a first pattern layer shown in FIG. 3;

FIG. 4b is a plan view of a second pattern layer shown in FIG. 3;

FIG. 4c is a plan view of a third pattern layer shown in FIG. 3;

FIG. 5a is a view showing combined cross-sections I-I′ of FIGS. 4a to 4c;

FIG. 5b is a view showing combined cross-sections II-II′ of FIGS. 4a to 4c;

FIG. 6 is a view schematically showing the state in which the inductor in accordance with an embodiment of the present invention is combined with a substrate; and

FIGS. 7a to 7s are process cross-sectional views for explaining a method of manufacturing an inductor in accordance with an embodiment of the present invention.

### DETAILED DESCRIPTION OF THE PREFERABLE EMBODIMENTS

Advantages and features of the present invention and methods of accomplishing the same will be apparent by referring to embodiments described below in detail in connection with the accompanying drawings. However, the present invention is not limited to the embodiments disclosed below and may be implemented in various different forms. The embodiments are provided only for completing the disclosure of the present invention and for fully representing the scope of the present invention to those skilled in the art. Like reference numerals refer to like elements throughout the specification.

Terms used herein are provided to explain embodiments, not limiting the present invention. Throughout this specification, the singular form includes the plural form unless the context clearly indicates otherwise. When terms “comprises” and/or “comprising” used herein do not preclude existence and addition of another component, step, operation and/or device, in addition to the above-mentioned component, step, operation and/or device.

For simplicity and clarity of illustration, the drawing figures illustrate the general manner of construction, and descriptions and details of well-known features and techniques may be omitted to avoid unnecessarily obscuring the discussion of the described embodiments of the invention. Additionally, elements in the drawing figures are not necessarily drawn to scale. For example, the dimensions of some of the elements in the figures may be exaggerated relative to other elements to help improve understanding of embodiments of the present invention. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments of the invention described herein are, for example, capable of operation in sequences other than those illustrated or otherwise described herein. Similarly, if a method is described herein as comprising a series of steps, the order of such steps as presented herein is not necessarily the only order in which such steps may be performed, and certain of the stated steps may possibly be omitted and/or certain other steps not described herein may possibly be added to the method. Furthermore, the terms “comprise,” “include,” “have,” and any variations thereof, are intended to cover a non-exclusive inclusion, such that a process, method, article, or apparatus that comprises a list of elements is not necessarily limited to those elements, but may include other elements not expressly listed or inherent to such process, method, article, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the invention described herein are, for example, capable of operation in other orientations than those illustrated or otherwise described herein. The term “coupled,” as used herein, is defined as directly or indirectly connected in an electrical or non-electrical manner. Objects described herein as being “adjacent to” each other may be in physical contact with each other, in close proximity to each other, or in the same general region or area as each other, as appropriate for the context in which the phrase is used. Occurrences of the phrase “in one embodiment” herein do not necessarily all refer to the same embodiment.

Hereinafter, configurations and operational effects of the present invention will be described in detail with reference to the accompanying drawings.

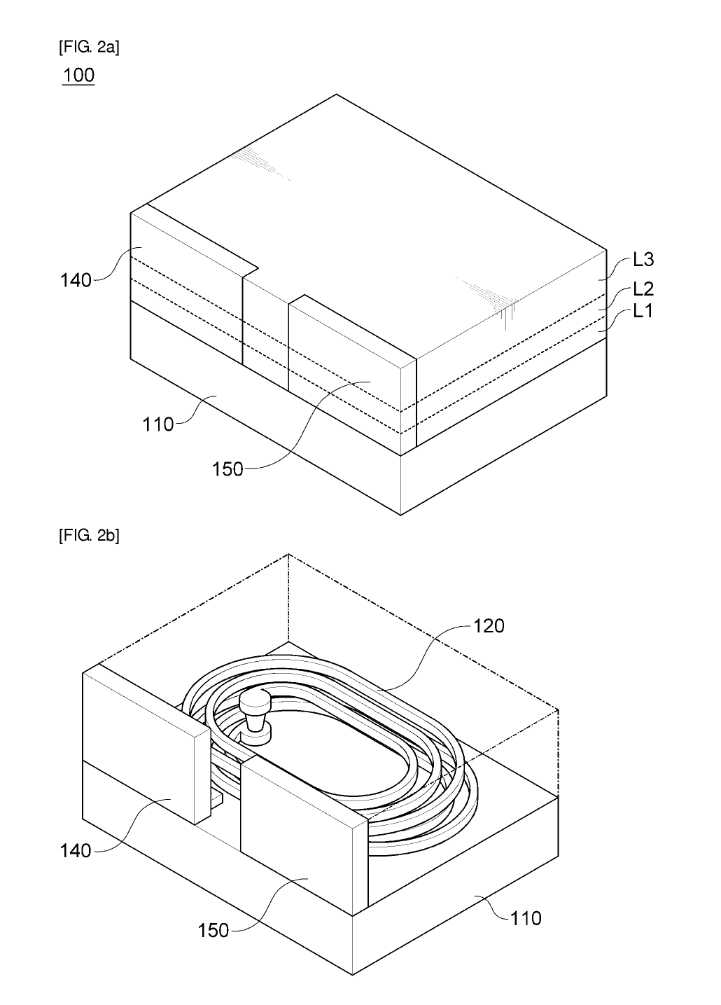

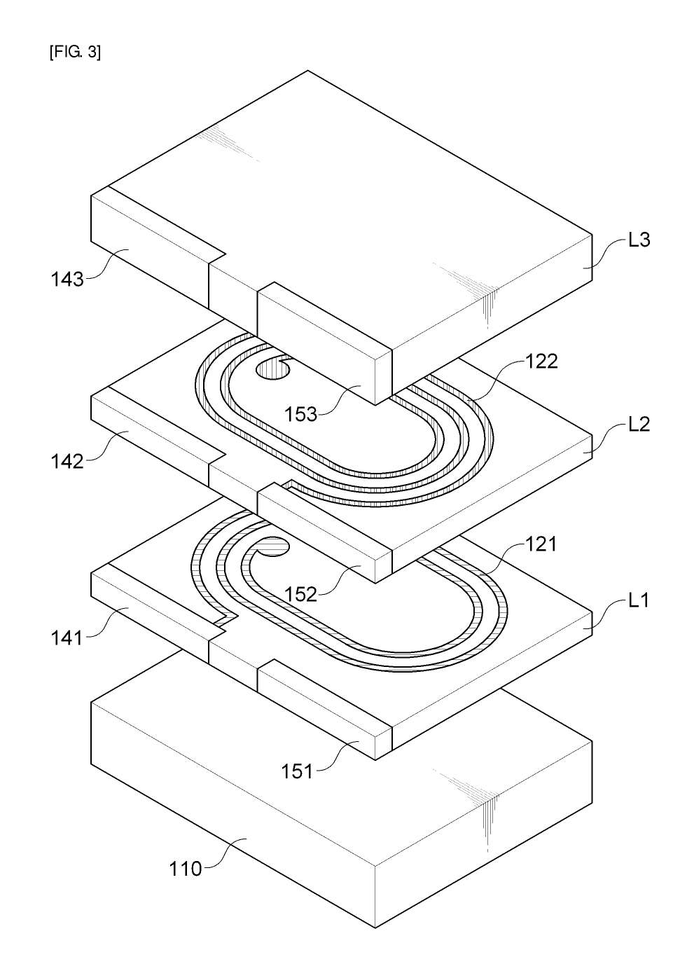

FIG. 2a is a view schematically showing an inductor 100 in accordance with an embodiment of the present invention, FIG. 2b is a view schematically showing a main part of the inductor 100 in accordance with an embodiment of the present invention, and FIG. 3 is a combined perspective view schematically showing the inductor 100 in accordance with an embodiment of the present invention.

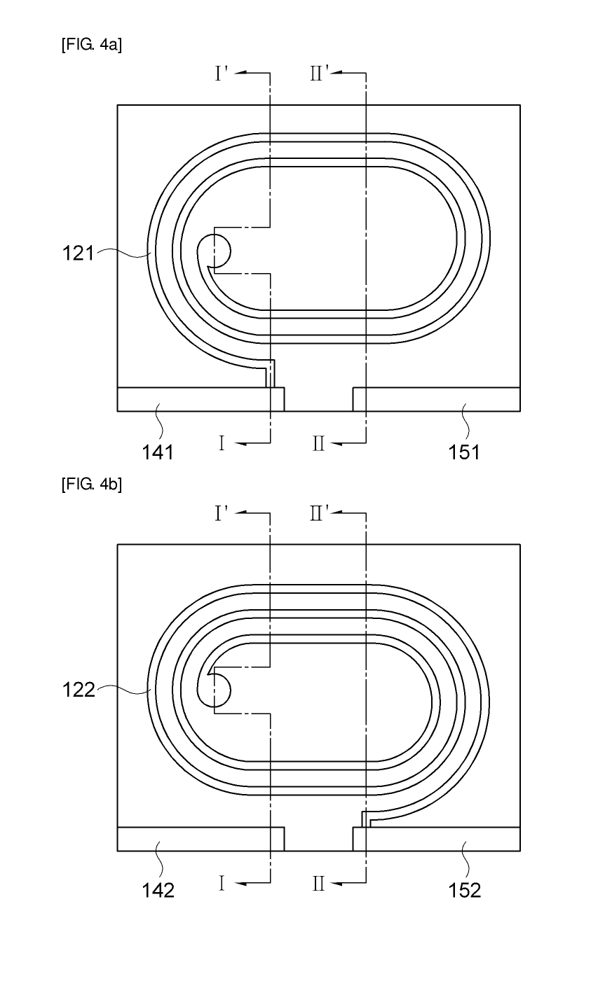

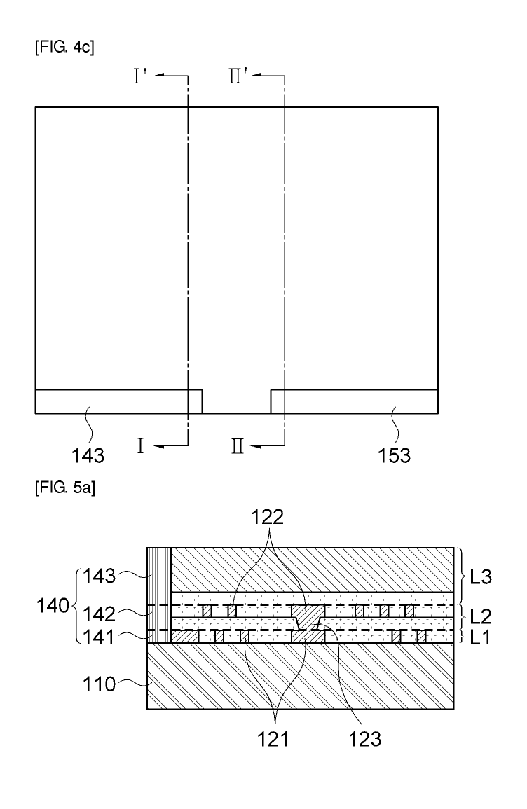

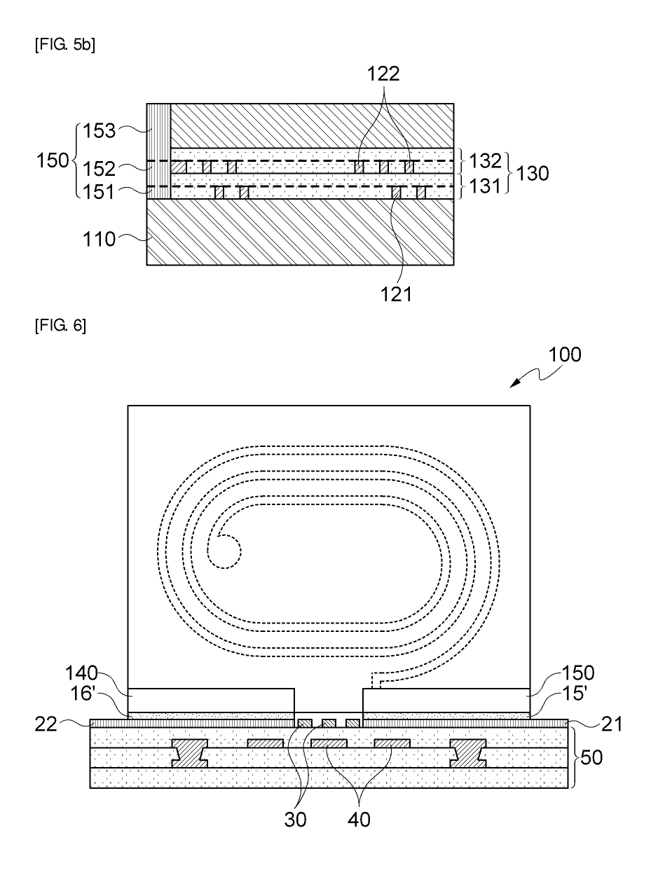

Further, FIG. 4a is a plan view of a first pattern layer L1 shown in FIG. 3, FIG. 4b is a plan view of a second pattern layer L2 shown in FIG. 3, FIG. 4c is a plan view of a third pattern layer L3 shown in FIG. 3, FIG. 5a is a view showing combined I-I′ cross-sections of FIGS. 4a to 4c, and FIG. 5b is a view showing combined II-II′ cross-sections of FIGS. 4a to 4c.

Referring to FIGS. 2a to 5b, the inductor 100 in accordance with an embodiment of the present invention may include a coil pattern portion 120, an insulating portion 130, a first external electrode portion 140, and a second external electrode portion 150.

Like a typical inductor 100, the coil pattern portion 120 is formed in the shape in which a conductive wire is wound to implement inductance, and the number of turns and layers may be variously determined according to the need.

In the present embodiment, the inductor 100 in accordance with an embodiment of the present invention will be described by taking a representative example in which the coil pattern portion 120 includes a first coil pattern 121 and a second coil pattern 122.

However, it will be easily appreciated by those skilled in the art that the coil pattern portion 120 can be formed in one layer or more than three layers.

The coil pattern portion 120 may be formed on a surface of a base substrate 110.

That is, after the first coil pattern 121 is formed on one surface of the base substrate 110, the second coil pattern 122 is formed in a state in which insulation is secured by the insulating portion 130.

When the first coil pattern 121 and the second coil pattern 122 are formed on different layers, the first coil pattern 121 and the second coil pattern 122 can be electrically connected using connection means such as a via 123.

Meanwhile, the first external electrode portion 140 and the second external electrode portion 150 may be electrically connected to one end and the other end of the coil pattern portion 120, respectively.

That is, one end of the first coil pattern 121 may be connected to the first external electrode portion 140, the other end of the first coil pattern 121 may be connected to the other end of the second coil pattern 122, and one end of the second coil pattern 122 may be connected to the second external electrode portion 150.

Accordingly, the first external electrode portion 140, the coil pattern portion 120, and the second external electrode portion 150 are electrically conducted to implement inductance.

Further, the inductor 100 may be implemented by further including the base substrate 110, a resin portion 160, etc. according to the need.

Further, an additional plating layer made of materials such as nickel or tin may be provided on surfaces of the first external electrode portion 140 and the second external electrode portion 150.

Meanwhile, as described above, in case of the conventional typical inductor 100, external electrodes are formed on two opposite surfaces of the inductor 100.

However, in the inductor 100 in accordance with an embodiment of the present invention, both of the first external electrode portion 140 and the second external electrode portion 150 are formed on one surface of the six surfaces of the inductor 100.

Further, among the surfaces of the first external electrode portion 140 and the second external electrode portion 150, the surface vertical to the surface on which the coil pattern portion is wound may be larger than the other surfaces.

Further, the first external electrode portion 140 and the second external electrode portion 150 may be provided only in the region outside the region on which the coil pattern portion 120 is projected in the direction vertical to the surface on which the coil pattern portion 120 is wound.

Further, lower surfaces of the first external electrode portion 140 and the second external electrode portion 150 may be positioned on the same horizontal plane as a lower surface of the coil pattern portion 120, and upper surfaces thereof may be formed in a position higher than the upper surface of the coil pattern portion 120.

Accordingly, it is possible to remarkably reduce interference with a flow of magnetic flux formed around the coil pattern portion 120 by the first external electrode portion 140 and the second external electrode portion 150.

Further, the inductor 100 in accordance with an embodiment of the present invention configured as above can be efficiently mounted on a substrate etc. compared to the conventional inductor.

FIG. 6 is a view schematically showing the state in which the inductor 100 in accordance with an embodiment of the present invention is combined with a substrate.

Referring to FIG. 6, the inductor 100 may be mounted so that the largest surface of the exposed surfaces of the first external electrode portion 140 and the second external electrode portion 150 is in contact with a connection pad 22 of the substrate. At this time, solder 15′ and 16′ may be provided between the first external electrode portion 140 and the second external electrode portion 150 and the connection pad 22.

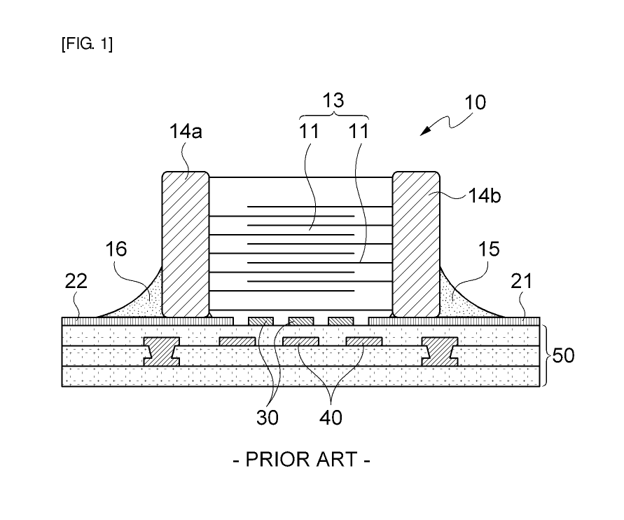

Accordingly, as shown in FIG. 1, as solder is applied on side surfaces of the external electrodes of the inductor 100, while there is a limit in reducing the area required for mounting the inductor 100, the inductor 100 in accordance with an embodiment of the present invention can reduce the mounting area due to the solder.

In addition, as shown in FIG. 6, since a region in which the coil pattern portion 120 and circuit patterns 30 and 40 of the substrate are parallel to each other is minimized, parasitic capacitance can be minimized.

Hereinafter, in order to understand a structure of the inductor 100 in accordance with an embodiment of the present invention in more detail, the inductor 100 in accordance with an embodiment of the present invention will be described by being divided into a first pattern layer L1, a second pattern layer L2, and a third pattern layer L3.

Referring to FIGS. 2a to 5b, the inductor 100 in accordance with an embodiment of the present invention may include the base substrate 110, the first pattern layer L1, the second pattern layer L2, and the third pattern layer L3.

First, the base substrate 110 may play roles of a support for forming the first coil pattern 121 and a housing of the completed inductor 100 at the same time.

The first pattern layer L1, which is a layer provided on an upper surface of the base substrate 110, may include the first coil pattern 121, a first external electrode first layer 141, a second external electrode first layer 151, and a portion of a first insulating layer 131.

Here, the first coil pattern 121 is an element which forms the coil pattern portion 120, the first external electrode first layer 141 is an element which forms the first external electrode portion 140, and the second external electrode first layer 151 is an element which forms the second external electrode portion 150.

The first coil pattern 121, the first external electrode first layer 141, and the second external electrode first layer 151 may be formed on the upper surface of the base substrate 110 at the same time. All of the first coil pattern 121, the first external electrode first layer 141, and the second external electrode first layer 151 may be made of a conductive material and formed by printing the conductive material on the base substrate 110.

Further, the first coil pattern 121, the first external electrode first layer 141, and the second external electrode first layer 151 may be formed by a photoresist method.

The first insulating layer 131, which is made of an insulating material, may be provided on the surfaces of the first coil pattern 121, the first external electrode first layer 141, and the second external electrode first layer 151 which are formed as above.

The second pattern layer L2, which is a layer including an upper portion of the first insulating layer 131, may include the second coil pattern 122, a first external electrode second layer 142, a second external electrode second layer 152, and a portion of a second insulating layer 132.

Here, the second coil pattern 122 is an element which forms the coil pattern portion 120, the first external electrode second layer 142 is an element which forms the first external electrode portion 140, and the second external electrode second layer 152 is an element which forms the second external electrode portion 150.

The second coil pattern 122, the first external electrode second layer 142, and the second external electrode second layer 152 may be formed on an upper surface of the first insulating layer 131 at the same time. All of the second coil pattern 122, the first external electrode second layer 142, and the second external electrode second layer 152 may be made of a conductive material and formed by printing the conductive material on the base substrate 110.

Further, the second coil pattern 122, the first external electrode second layer 142, and the second external electrode second layer 152 may be formed by a photoresist method.

The second insulating layer 132, which is made of an insulating material, may be provided on the surfaces of the second coil pattern 122, the first external electrode second layer 142, and the second external electrode second layer 152.

The third pattern layer L3, which is a layer including an upper portion of the second insulating layer 132, may include a first external electrode third layer 143, a second external electrode third layer 153, and the resin portion 160.

At this time, the resin portion 160 may play a role of the housing of the completed inductor 100.

As described above, the inductor 100 in accordance with an embodiment of the present invention can be implemented by combining the base substrate 110, the first pattern layer L1, the second pattern layer L2, and the third pattern layer L3.

At this time, an upper surface of the first external electrode first layer 141 and a lower surface of the first external electrode second layer 142 may be electrically connected to each other, an upper surface of the first external electrode second layer 142 and a lower surface of the first external electrode third layer 143 may be electrically connected to each other, and a combination of the first external electrode first layer 141, the first external electrode second layer 142, and the first external electrode third layer 143 may be referred to as the first external electrode portion 140.

Further, an upper surface of the second external electrode first layer 151 and a lower surface of the second external electrode second layer 152 may be electrically connected to each other, an upper surface of the second external electrode second layer 152 and a lower surface of the second external electrode third layer 153 may be electrically connected to each other, and a combination of the second external electrode first layer 151, the second external electrode second layer 152, and the second external electrode third layer 153 may be referred to as the second external electrode portion 150.

Further, the other end of the first coil pattern 121 and the other end of the second coil pattern 122 may be electrically connected through the via 123 and so on, and a combination of the first coil pattern 121 and the second coil pattern 122 may be referred to as the coil pattern portion 120.

Here, one end of the first coil pattern 121 may be electrically connected to the first external electrode portion 140, and one end of the second coil pattern 122 may be electrically connected to the second external electrode portion 150.

Accordingly, the first external electrode portion 140, the coil pattern portion 120, and the second external electrode portion 150 may be electrically conducted to implement inductance.

Meanwhile, in the inductor 100 in accordance with an embodiment of the present invention, both of the first external electrode portion 140 and the second external electrode portion 150 may be formed on one surface of the six surfaces of the inductor 100.

Further, among the surfaces of the first external electrode portion 140 and the second external electrode portion 150, the surface vertical to the surface on which the coil pattern portion 120 is wound may be larger than the other surfaces.

Further, the first external electrode portion 140 and the second external electrode portion 150 may be provided only in the region outside the region on which the coil pattern portion 120 is projected in the direction vertical to the surface on which the coil pattern portion 120 is wound.

Further, the lower surfaces of the first external electrode portion 140 and the second external electrode portion 150 may be positioned on the same horizontal plane as the lower surface of the first coil pattern 121, and the upper surfaces thereof may be formed in the position higher than the upper surface of the second coil pattern 122.

Accordingly, it is possible to remarkably reduce interference with a flow of magnetic flux formed around the coil pattern portion 120 by the first external electrode portion 140 and the second external electrode portion 150.

Further, the inductor 100 in accordance with an embodiment of the present invention configured as above can be efficiently mounted on a substrate etc. compared to the prior inductor.

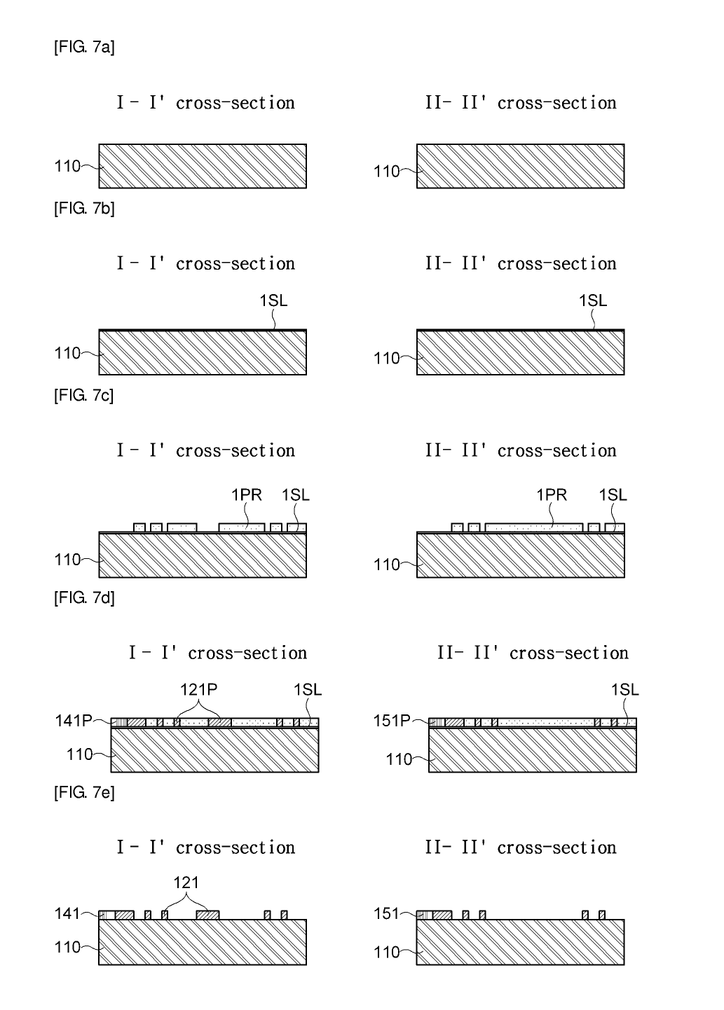

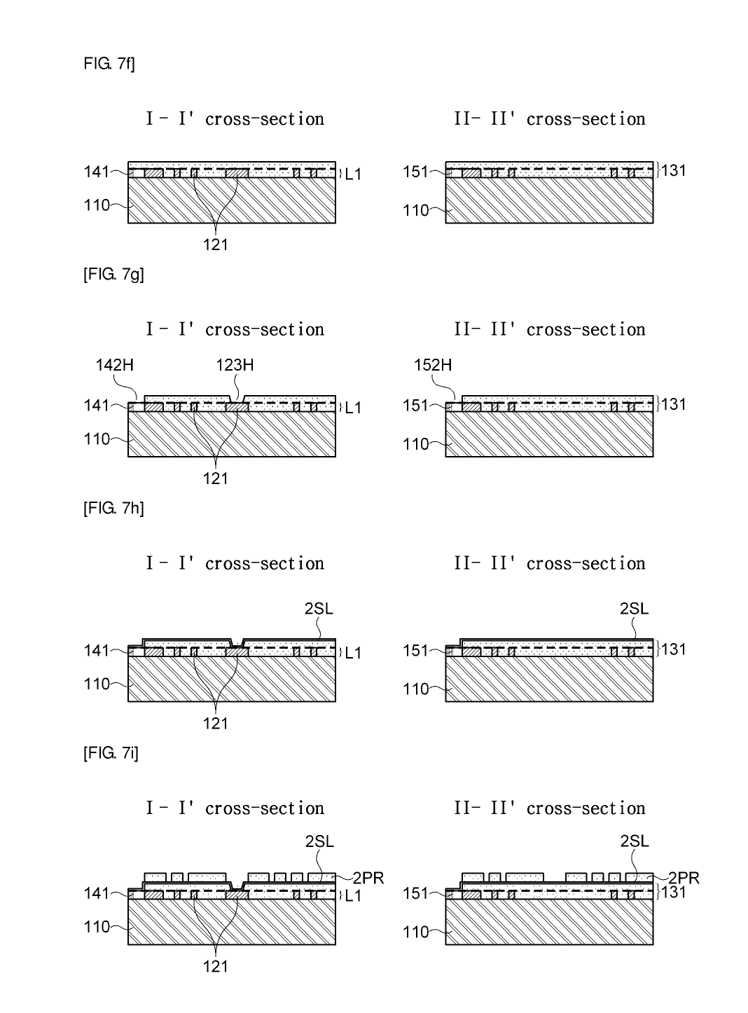

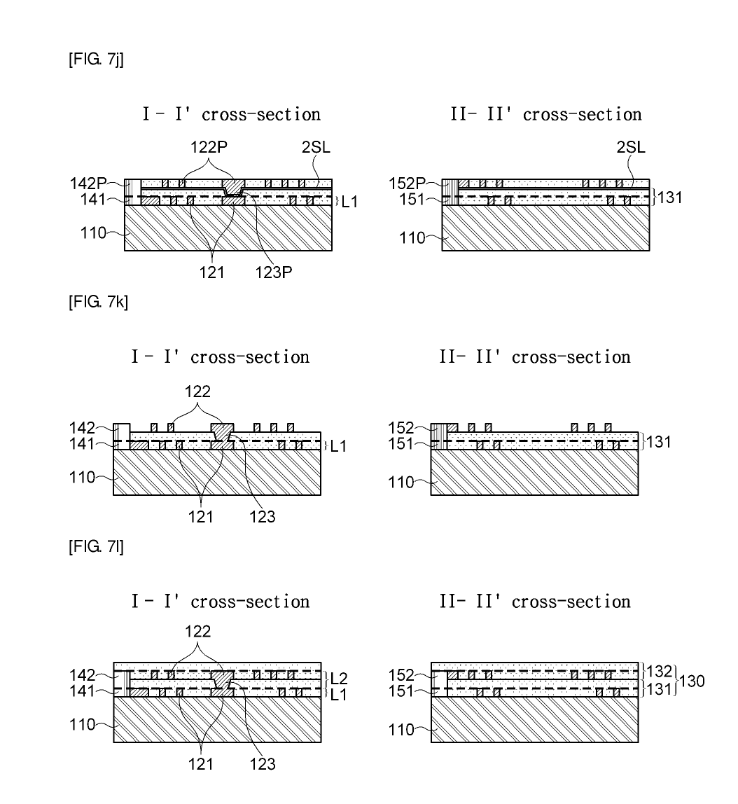

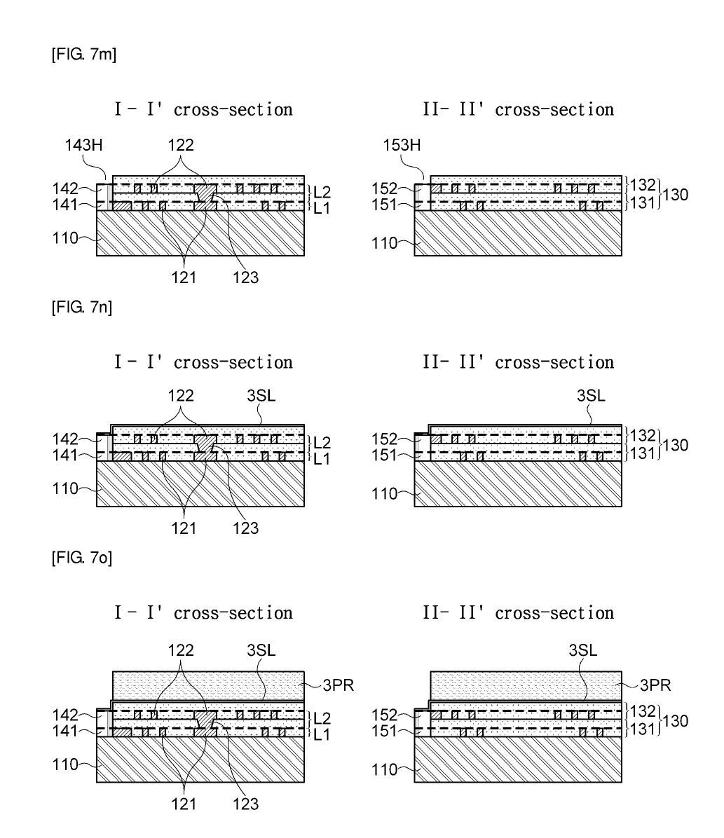

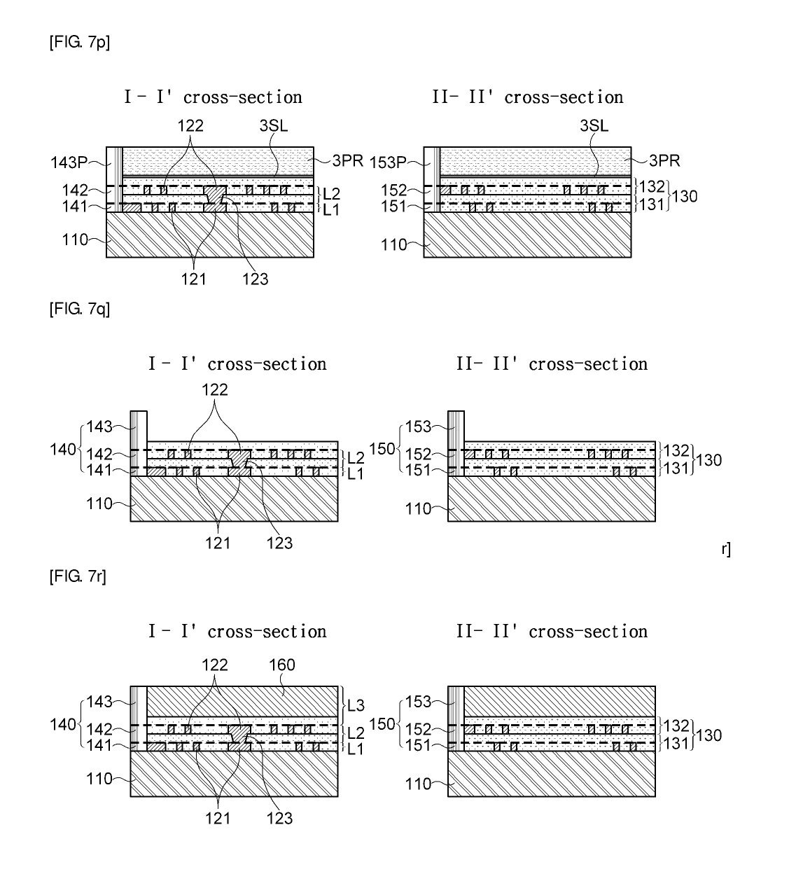

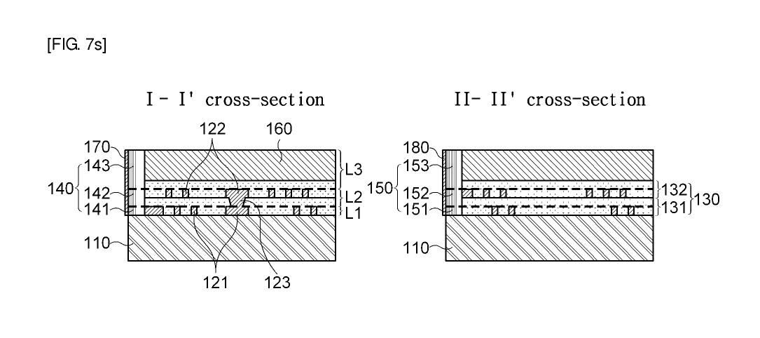

FIGS. 7a to 7s are process cross-sectional views for explaining a method of manufacturing an inductor 100 in accordance with an embodiment of the present invention.

Referring to FIGS. 7a to 7s, first, a base substrate 110 is provided (FIG. 7a), and a first seed layer 1SL is formed on a surface of the provided base substrate 110 (FIG. 7b).

Next, a first photoresist pattern layer 1PR is formed on a surface of the first seed layer 1SL (FIG. 7c).

At this time, in the first photoresist pattern layer 1PR, regions in which a first coil pattern 121, a first external electrode first layer 141, and a second external electrode first layer 151 are to be formed are penetrated to expose the first seed layer 1SL in the corresponding regions.

Next, a plating portion is formed by performing a plating process (FIG. 7d). At this time, a first coil plating portion 121p is formed in the region in which the first coil pattern 121 is to be formed, a first external electrode first layer plating portion 141p is formed in the region in which the first external electrode first layer 141 is to be formed, and a second external electrode first layer plating portion 151p is formed in which the second external electrode first layer 151 is to be formed.

Next, the first photoresist pattern layer 1PR and the first seed layer 1SL under the first photoresist pattern layer 1PR are removed (FIG. 7e).

Accordingly, the first coil pattern 121, the first external electrode first layer 141, and the second external electrode first layer 151 are formed on one surface of the base substrate 110.

Here, the first coil pattern 121 includes the first coil plating portion 121p and the first seed layer 1SL under the first coil plating portion 121p, but for simplicity of the drawing, in describing the first coil pattern 121, a distinction between the first coil plating portion 121p and the first seed layer 1SL will be omitted.

Further, the same is for the first external electrode first layer 141 and the second external electrode first layer 151, and a second coil pattern 122, a first external electrode second layer 142, a second external electrode second layer 152, a first external electrode third layer 143, and a second external electrode third layer 153, which are described later, will be described in a similar way.

Next, a first insulating layer 131 is formed (FIG. 7f).

Here, the first insulating layer 131 may be formed to cover the first coil pattern 121, the exposed surfaces of the first external electrode first layer 141 and the second external electrode first layer 151, and the exposed upper surface of the base substrate 110.

Further, the first insulating layer 131 may be made of a photosensitive insulating material.

Next, a portion of the first insulating layer 131 is removed (FIG. 7g).

At this time, a via-hole 123h for electrically connecting the first coil pattern 121 and the second coil pattern 122 may be formed by removing the first insulating layer 131 covered on an upper surface of a portion of the first coil pattern 121.

Further, a first external electrode second layer plating hole 142h and a second external electrode second layer plating hole 152h may be formed by removing the first insulating layer 131 covered on the upper surfaces of the first external electrode first layer 141 and the second external electrode first layer 151.

Here, when the first insulating layer 131 is made of a photosensitive insulating material, the process of removing the portion of the first insulating layer 131 may be performed by developing after exposing the region to be removed.

Further, the process of removing the portion of the first insulating layer 131 may be performed by a physical removing method using laser or a selective etching method.

Next, a second seed layer 2SL is formed on the removed portion of the first insulating layer 131 and the surface of the first insulating layer 131 (FIG. 7h).

Next, a second photoresist pattern layer 2PR is formed on an upper surface of the second seed layer 2SL.

At this time, in the second photoresist pattern layer 2PR, regions in which the second coil pattern 122, the first external electrode second layer 142, and the second external electrode second layer 152 are to be formed are penetrated to expose the second seed layer 2SL in the corresponding regions.

Next, a plating portion is formed by performing a plating process (FIG. 7j). At this time, a via plating portion 123p is formed in a region in which a via 123 is to be formed, a second coil plating portion 122p is formed in the region in which the second pattern 122 is to be formed, a first external electrode second layer plating portion 142p is formed in the region in which the first external electrode second layer 142 is to be formed, and a second external electrode second layer plating portion 152p is formed in the region in which the second external electrode second layer 152 is to be formed.

Next, the second photoresist pattern layer 2PR and the second seed layer 2SL under the second photoresist pattern layer 2PR are removed (FIG. 7k).

Accordingly, the second coil pattern 122, the first external electrode second layer 142, and the second external electrode second layer 152 are formed on one surface of the first insulating layer 131.

Next, a second insulating layer 132 is formed (FIG. 7l).

Here, the second insulating layer 132 may be formed to cover the second coil pattern 122, the exposed surfaces of the first external electrode second layer 142 and the second external electrode second layer 152, and the exposed upper surface of the base substrate 110.

Further, the second insulating layer 132 may be made of a photosensitive insulating material.

Next, a portion of the second insulating layer 132 is removed (FIG. 7m).

At this time, a first external electrode third layer plating hole 143h and a second external electrode third layer plating hole 153h may be formed by removing the second insulating layer 132 covered on the upper surfaces of the first external electrode second layer 142 and the second external electrode second layer 152.

Here, when the second insulating layer 132 is made of a photosensitive insulating material, the process of removing the portion of the second insulating layer 132 may be performed by developing after exposing the region to be removed.

Further, the process of removing the portion of the second insulating layer 132 may be performed by a physical removing method using laser or a selective etching method.

Next, a third seed layer 3SL is formed on the removed portion of the second insulating layer 132 and the surface of the second insulating layer 132 (FIG. 7n).

Next, a third photoresist pattern layer 3PR is formed on an upper surface of the third seed layer 3SL.

At this time, in the third photoresist pattern layer 3PR, regions in which the first external electrode third layer 143 and the second external electrode third layer 153 are to be formed are penetrated to expose the third seed layer 3SL in the corresponding regions.

Next, a plating portion is formed by performing a plating process (FIG. 7p). At this time, a first external electrode third layer plating portion 143p is formed in the region in which the first external electrode third layer 143 is to be formed, and a second external electrode third layer plating portion 153p is formed in the region in which the second external electrode third layer 153 is to be formed.

Next, the third photoresist pattern layer 3PR and the third seed layer 3SL under the third photoresist pattern layer 3PR are removed (FIG. 7q).

Next, a resin portion 160 is formed on an upper surface of the second insulating layer 132 (FIG. 7r).

Next, a first additional plating portion 170 and a second additional plating portion 180 are formed by plating nickel or tin on surfaces of a first external electrode portion 140 and a second external electrode portion 150 (FIG. 7s).

Accordingly, since an external electrode can be formed without a separate dipping process, it is possible to improve process efficiency compared to the conventional inductor 100 in which a dipping process should be preformed to form an external electrode.

An object of the present invention invented in order to overcome the above-described problems is to provide an inductor capable of minimizing the area required for mounting, reducing parasitic capacitance generated between a circuit pattern of a substrate and a coil pattern of the inductor, and being efficiently manufactured.

Further, another object of the present invention is to provide an inductor capable of improving inductance and Q characteristics by preventing interference with a magnetic flux generated according to a current flow in a coil pattern portion.

Further, another object of the present invention is to provide a method of manufacturing an inductor that can minimize the area required for mounting, reduce parasitic capacitance generated between a circuit pattern of a substrate and a coil pattern of the inductor, and improve manufacturing efficiency.

Further, another object of the present invention is to provide a method of manufacturing an inductor that can improve inductance and Q characteristics by preventing interference with a magnetic flux generated according to a current flow in a coil pattern portion.

What is claimed is:

1. An inductor having a hexahedral shape, comprising:
a coil pattern portion formed by winding a conductive wire made of a conductive material on at least one plane at least more than one turn;
an insulating portion having the coil pattern portion inside;
a first external electrode portion having at least one surface exposed to an outer surface of the insulating portion and electrically connected to one end of the coil pattern portion; and
a second external electrode portion having at least one surface exposed to the outer surface of the insulating portion and electrically connected to the other end of the coil pattern portion,
wherein both of the first external electrode portion and the second external electrode portion are provided on one of six surfaces of the inductor.

2. The inductor according to claim 1, wherein the surface of the first external electrode portion and the second external electrode portion, which is vertical to the surface on which the coil pattern portion is wound, has a larger area than the other surfaces.

3. The inductor according to claim 1, wherein the first external electrode portion and the second external electrode portion are provided only in a region outside the region on which the coil pattern portion is projected in the direction vertical to the surface on which the coil pattern portion is wound.

4. The inductor according to claim 2, wherein the first external electrode portion and the second external electrode portion are provided only in a region outside the region on which the coil pattern portion is projected in the direction vertical to the surface on which the coil pattern portion is wound.

5. The inductor according to claim 4, wherein one of the surfaces of the first external electrode portion and the second external electrode portion, which are parallel to the surface on which the coil pattern portion is wound, is parallel to a lower surface of the coil pattern portion, and
the other of the surfaces of the first external electrode portion and the second external electrode portion, which are parallel to the surface on which the coil pattern portion is wound, is formed in a position higher than an upper surface of the coil pattern portion.

6. An inductor comprising a base substrate, a first pattern layer, a second pattern layer, and a third pattern layer,
wherein the first pattern layer comprises a first coil pattern, a first external electrode first layer electrically connected to one end of the first coil pattern, a second external electrode first layer, and a first insulating layer while being provided on an upper surface of the base substrate,
the second pattern layer comprises a second coil pattern, a first external electrode second layer, a second external electrode second layer electrically connected to one end of the second coil pattern, and a second insulating layer while being provided on an upper surface of the first pattern layer,
the third pattern layer comprises a first external electrode third layer, a second external electrode third layer, and a resin portion while being provided on an upper surface of the second pattern layer,
the other end of the first coil pattern and the other end of the second coil pattern are electrically connected through a via,
an upper surface of the first external electrode first layer is in contact with a lower surface of the first external electrode second layer and an upper surface of the first external electrode second layer is in contact with a lower surface of the first external electrode third layer so that the first external electrode first layer, the first external electrode second layer, and the first external electrode third layer form a first external electrode portion,
an upper surface of the second external electrode first layer is in contact with a lower surface of the second external electrode second layer and an upper surface of the second external electrode second layer is in contact with a lower surface of the second external electrode third layer so that the second external electrode first layer, the second external electrode second layer, and the second external electrode third layer form a second external electrode portion, and
all of the base substrate, the first pattern layer, the second pattern layer, and the third pattern layer have a hexahedral shape, and the first external electrode portion and the second external electrode portion are provided on the same plane.

7. An inductor comprising:
a hexahedral base substrate;
a first coil pattern provided by forming a pattern made of a conductive material on an upper surface of the base substrate in a coil shape;
a first external electrode first layer formed of a conductive material on an upper surface of the base substrate and connected to one end of the first coil pattern;
a second external electrode first layer formed of a conductive material on the upper surface of the base substrate and positioned on the same surface as the surface on which the first external electrode first layer is positioned among the four surfaces vertical to the upper surface of the base substrate;
a first insulating layer for covering an exposed surface of the first coil pattern and the upper surface of the base substrate;
a second coil pattern provided by forming a pattern made of a conductive material on an upper surface of the first insulating layer in a coil shape;
a second external electrode second layer formed of a conductive material on an upper surface of the second external electrode first layer and connected to one end of the second coil pattern;
a first external electrode second layer formed of a conductive material on an upper surface of the first external electrode first layer;
a second insulating layer for covering an exposed surface of the second coil pattern and the upper surface of the first insulating layer;
a first external electrode third layer formed of a conductive material on an upper surface of the first external electrode second layer;
a second external electrode third layer formed of a conductive material on an upper surface of the second external electrode second layer; and
a resin portion for covering an upper surface of the second insulating layer.

8. The inductor according to claim 7, wherein a first external electrode portion consisting of the first external electrode first layer, the first external electrode second layer, and the first external electrode third layer and a second external electrode portion consisting of the second external electrode first layer, the second external electrode second layer, and the second external electrode third layer are provided only in a region outside the region on which the first coil pattern and the second coil pattern are projected in the direction vertical to the upper surface of the base substrate.

9. A method of manufacturing an inductor, comprising:
(A) forming a first coil pattern, a second external electrode first layer, and a first external electrode first layer electrically connected to one end of the first coil pattern on a surface of a base substrate;
(B) forming a first insulating layer for covering the first coil pattern, the first external electrode first layer, an exposed surface of the second external electrode first layer, and an upper surface of the base substrate;
(C) removing the first insulating layer on a portion of the first coil pattern, an upper surface of the first external electrode first layer, and an upper surface of the second external electrode first layer;
(D) forming a second coil pattern having one end electrically connected to the portion of the first coil pattern, a first external electrode second layer in contact with the upper surface of the first external electrode first layer, and a second external electrode second layer electrically connected to the other end of the second coil pattern and in contact with the upper surface of the second external electrode first layer on an upper surface of the first insulating layer;
(E) forming a second insulating layer for covering the second coil pattern, the first external electrode second layer, an exposed surface of the second external electrode second layer, and the upper surface of the first insulating layer;
(F) removing the second insulating layer on an upper surface of the first external electrode second layer and an upper surface of the second external electrode second layer; and
(G) forming a first external electrode third layer having a lower surface in contact with the upper surface of the first external electrode second layer, a second external electrode third layer having a lower surface in contact with the upper surface of the second external electrode second layer, and a resin portion provided on an upper surface of the second insulating layer.

10. The method of manufacturing an inductor according to claim 9, wherein the steps (A), (D), and (G) comprise:
forming a seed layer;
forming a photoresist pattern on an upper surface of the seed layer;
forming a plating portion by performing plating using the seed layer and the photoresist pattern; and
removing the photoresist pattern and the seed layer in the remaining region of the seed layer in which the plating portion is not formed.

11. The method of manufacturing an inductor according to claim 9, wherein the first insulating layer and the second insulating layer are made of a photosensitive insulating material,
the step (B) is performed by developing after exposing a portion of the first insulating layer, and
the step (F) is performed by developing after exposing a portion of the second insulating layer.

12. The method of manufacturing an inductor according to claim 10, wherein a first external electrode portion consisting of the first external electrode first layer, the first external electrode second layer, and the first external electrode third layer and a second external electrode portion consisting of the second external electrode first layer, the second external electrode second layer, and the second external electrode third layer are provided only in a region outside the region on which the first coil pattern and the second coil pattern are projected in the direction vertical to the upper surface of the base substrate.

13. The method of manufacturing an inductor according to claim 12, further comprising, after the step (G), plating nickel or tin on at least one of exposed surfaces of the first external electrode portion and the second external electrode portion.

14. A method of manufacturing an inductor having a hexahedral shape, which forms a coil pattern portion formed by winding a conductive wire made of a conductive material on at least one plane at least more than one turn, a first external electrode portion electrically connected to one end of the coil pattern portion, and a second external electrode portion electrically connected to the other end of the coil pattern portion on one surface of a base substrate,
wherein the coil pattern portion, the first external electrode portion, and the second external electrode portion are formed by a photoresist method, and
the first external electrode portion and the second external electrode portion are formed only in a region outside the region on which the coil pattern portion is projected in the direction vertical to the surface on which the coil pattern portion is wound.

15. The method of manufacturing an inductor according to claim 14, wherein one of surfaces of the first external electrode portion and the second external electrode portion, which are parallel to the surface on which the coil pattern portion is wound, is parallel to a lower surface of the coil pattern portion, and
the other of the surfaces of the first external electrode portion and the second external electrode portion, which are parallel to the surface on which the coil pattern portion is wound, is formed in a position higher than an upper surface of the coil pattern portion.
